(19) United States
(12) Patent Application Publication
(10) Pub. No.: US 2012/0212426 A1
(43) Pub. Date: Aug. 23, 2012

(54) TRANSPARENT TOUCH PAD AND METHOD FOR MANUFACTURING THE SAME

(75) Inventors: Jao-Ching Lin, Taipei City (TW); Abel Lin Chu, Taipei City (TW)

(73) Assignee: SENTELIC CORPORATION, Taipei City (TW)

(21) Appl. No.: 13/053,753

(22) Filed: Mar. 22, 2011

(30) Foreign Application Priority Data
Feb. 21, 2011 (TW) 100105614

(51) Int. Cl. G06F 3/041

(52) U.S. Cl. 345/173

(57) ABSTRACT

The present invention provides a transparent touch pad and a method for manufacturing the same. The transparent touch pad includes a first transparent substrate, a second transparent substrate and an adhesion layer. The adhesion sides of the first transparent substrate and the second transparent substrate are respectively provided with a plurality of first sensing conductors and second sensing conductors and are adhered by the adhesion layer to form a transparent touch pad having two-dimensional arrangement of sensing conductors. Since the first transparent substrate has a low electrical resistance and the second transparent substrate is easy to process, the area of a visible region of the touch pad is increased and a lithographic process is no longer required. In this way, the structure of the touch pad is simplified and the production cost is reduced.

This application claims the priority benefit of Taiwan patent application number 100105614 filed on Feb. 21, 2011.

### BACKGROUND OF THE INVENTION

1. Field of the Invention

The present invention relates to a transparent touch pad and a method for manufacturing the same. The transparent touch pad of the present invention has a simplified structure and its manufacture cost can be reduced. In addition, the present invention increases the visible region and improves the yield rate.

2. Description of Prior Art

Existing touch pads are primarily divided into four categories, including resistance-type, capacitance-type, acoustic-type and optical-type based on their principles of sensing signals. The capacitance-type touch pad is widely used as it is dust-proof and fire-resistant and has a high-definition. The capacitance-type touch pad is configured to identify the position of contact based on a change of capacitance. More specifically, the capacitance-type touch pad is configured to identify the coordinates of a contact point based on a change of capacitance between electrodes caused by the approach of an object (such as a finger or other conductors).

Many capacitance-type touch pads available in the market employ a glass substrate. The conventional capacitance-type touch pads are divided into two categories, including a single-piece single-surface structure and a single-piece double-surface structure. The capacitance-type touch pad of a single-piece double-surface structure has two-dimensional arrangement of sensing conductors. FIGS. 1a and 1b illustrate a cross-sectional view and a plan view of a conventional capacitance-type touch pad respectively. The touch pad 10 has a glass substrate 11. The upper and lower surfaces of the glass substrate 11 are coated with a plurality of first conductors 111 and second conductors 112, and are further covered by protection layers 12 respectively. An adhesion layer 13 is provided between the substrate 11 and the protection layers 12 to adhere the glass substrate 11 and the protection layers 12. The surfaces of the glass substrate 11 are subjected to a low-resistance treatment. Further, transparent electrical conductors are used as conductive wires 14 to electrically connect the first conductors 111 and the second conductors 112 to a flat cable 15, thereby increasing the area of visible region of the touch pad 10. However, when coating the first conductors 111 and the second conductors 112 on both surfaces of the glass substrate 11, a lithographic process is required to achieve a desired alignment with greater precision and consequently the production cost is increased.

The capacitance-type touch pad of a single-piece single-surface structure also has two-dimensional arrangement of sensing conductors. FIG. 1c is a cross-sectional view of another conventional capacitance-type touch pad respectively. The touch pad 10 has a glass substrate 11. The upper surface of the glass substrate 11 is coated with both the first conductors 111 and the second conductors 112. The connecting points of the first conductors 111 and the second conductors 112 are separated from each other by an insulation layer 16. Conductive wires 17 are used to connect adjacent second conductors 112. The protection layer 12 is covered on the upper surface of the glass substrate 11. The adhesion layer 13 is provided between the glass substrate 11 and the protection layer 12 to adhere the glass substrate 11 and the protection layer 12, thereby increasing the area of visible region of the touch pad 10. However, similar to the single-piece double-surface structure, when coating the first conductors 111 and the second conductors 112 on one surface of the glass substrate 11, a lithographic process is still required to achieve a desired alignment with greater precision, and the production cost is increased.

FIGS. 2a to 2d show cross-sectional views and a plan view of a further conventional touch pad. The touch pad 20 has at least two PET substrates 21. Each of the PET substrates 21 is coated with a plurality of first conductors 211 and a plurality of second conductors 212, and the first conductors 211 or the second conductors 212 can be coated on the upper surface or the lower surface of the PET substrate 21. Further, an optical glue layer 22 is used to adhere the PET substrates 21 and at least one protection layer 23. The silver glue, Mo—Al—Mo conductive wires or other opaque low-resistance conductors are used as the conductive wires 24, 25 to electrically connect the first conductors 211 and the second conductors 212 to a flat cable 26 when the PET substrates 21 are used as the substrates. Since the silver glue is opaque, the conductive wires 24 may seriously reduce the area of visible region of the touch pad 20. In addition, the more PET substrates 21 are used, the more complicated the process of manufacturing the touch pad 20 becomes and the higher the cost is. Further, the yield rate and light transmittance of the finished touch pad 20 are deteriorated.

According to the above, the conventional touch pad has problems as follows:

(1) a lithographic process is required;

(2) the production cost is high;

(3) the area of a visible region of the touch pad is reduced;

(4) the assembly and manufacture of the conventional touch pad involves complicated steps and increased cost.

Therefore, it is an important issue for the present Inventor and the manufacturers in this field to solve the above-mentioned problems of prior art.

### SUMMARY OF THE INVENTION

In order to solve the above problems, an objective of the present invention is to provide a transparent touch pad and a method for manufacturing the same, whereby the structure of the transparent touch pad is simplified and its production cost is reduced.

Another objective of the present invention is to provide a transparent touch pad and a method for manufacturing the same, whereby the area of a visible region of the transparent touch pad is increased and the yield rate is improved.

In order to achieve the above objectives, the present invention provides a transparent touch pad including a first transparent substrate, a second transparent substrate and an adhesion layer. The first transparent substrate has a first surface on which a plurality of first sensing conductors is provided. The second transparent substrate is disposed on one side of the first transparent substrate. The surface resistance of the first transparent substrate is smaller than that of the second transparent substrate. The second transparent substrate has a second surface on which a plurality of sensing conductors is provided. The second surface is adhered to the first surface. The adhesion layer is provided between the first transparent substrate and the second transparent substrate. The adhesion layer is used to adhere the first surface to the second surface, thereby forming a transparent touch pad having two-dimensional arrangement of sensing conductors. The first transparent substrate and the second transparent substrate are made by a glass substrate and a PET substrate respectively, so that a lithographic process is no longer required and only an etching process is utilized to finish the transparent touch pad of the present invention. Thus, the structure is simplified, the production cost is reduced, the area of a visible region and the yield of the transparent touch pad are increased.

The present invention further provides a method for manufacturing a transparent touch pad, including steps of: coating a plurality of first sensing conductors on one surface of a first transparent substrate with the first sensing conductors being electrically connected to each other along a first direction to form a plurality of first conductor groups, and coating a plurality of second sensing conductors on one surface of a second transparent substrate with the second sensing conductors being electrically connected to each other along a second direction to form a plurality of second conductor groups. The surface resistance of the first transparent substrate is smaller than that of the second transparent substrate. An adhesion layer is provided to adhere the first transparent substrate to the second transparent substrate. The first sensing conductors and the second sensing conductors are structurally adhered together and electrically insulated from each other. The first transparent substrate and the second transparent substrate are made by a glass substrate and a PET substrate respectively. Thus, a lithographic process is no longer required and only an etching process is utilized to manufacture the transparent touch pad of the present invention. In this way, the structure is simplified, the production cost is reduced, the area of a visible region and the yield of the present invention are increased.

Therefore, the present invention has the following advantages:

(1) simplified structure;

(2) easy to process;

(3) reduced production cost;

(4) increased area of visible region; and

(5) improved yield rate.

### BRIEF DESCRIPTION OF THE DRAWINGS

FIG. 1a is an exploded cross-sectional view (I) showing a conventional touch pad;

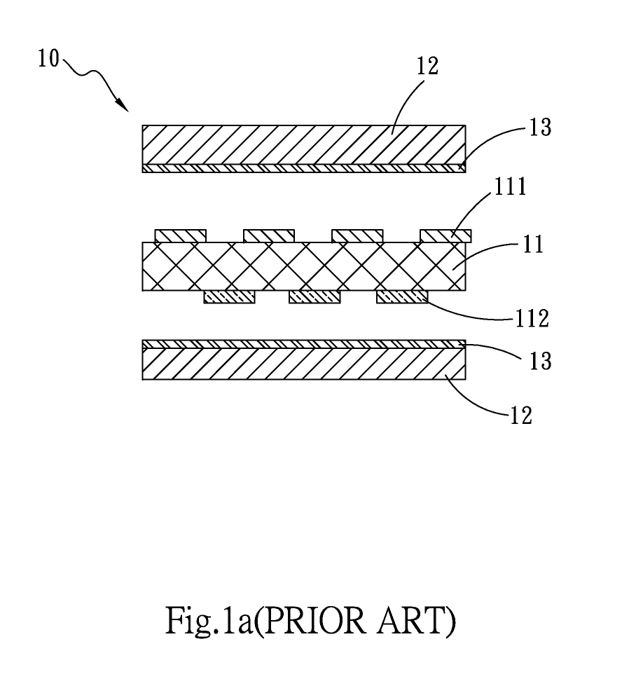

FIG. 1b is a plane view showing the conventional touch pad;

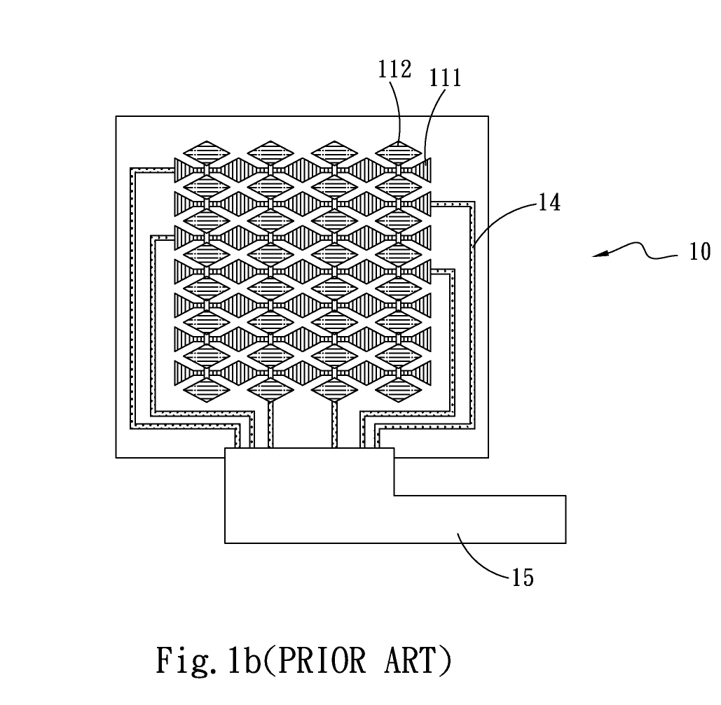

FIG. 1c is an exploded cross-sectional view (II) showing the conventional touch pad;

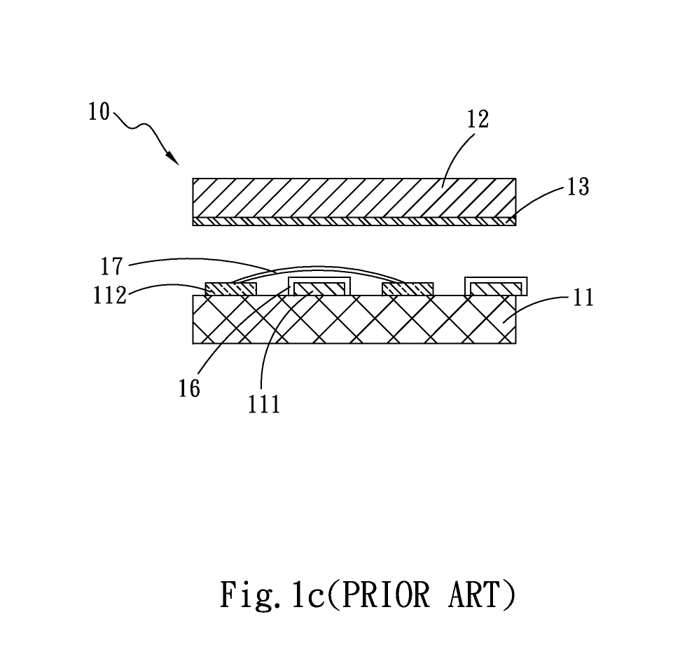

FIG. 2a is an exploded cross-sectional view (I) showing another conventional touch pad;

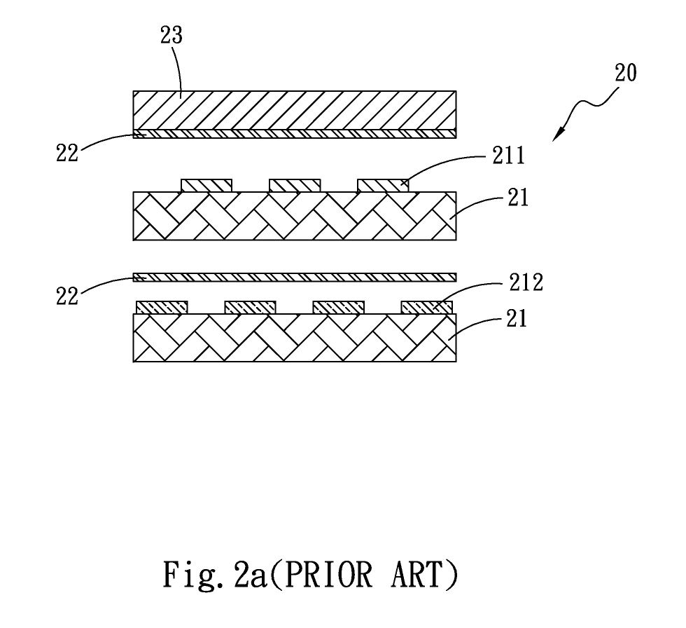

FIG. 2b is an exploded cross-sectional view (II) showing another conventional touch pad;

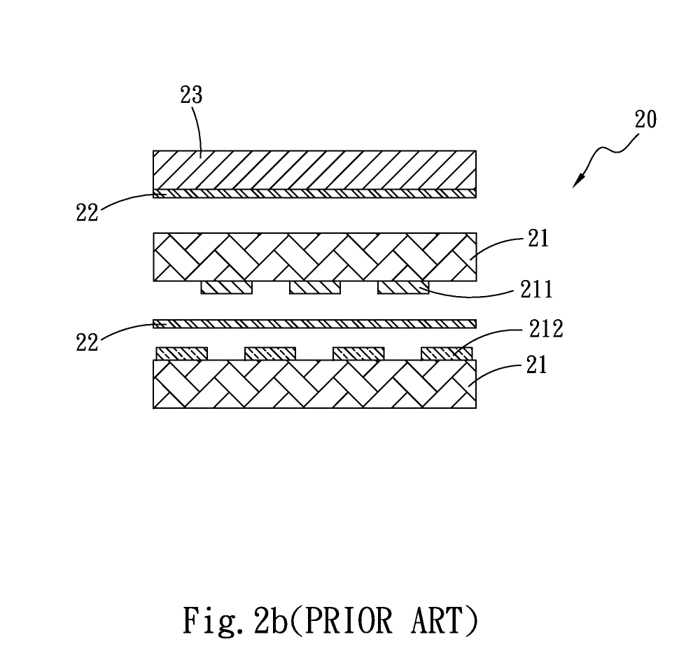

FIG. 2c is an exploded cross-sectional view (III) showing a further conventional touch pad;

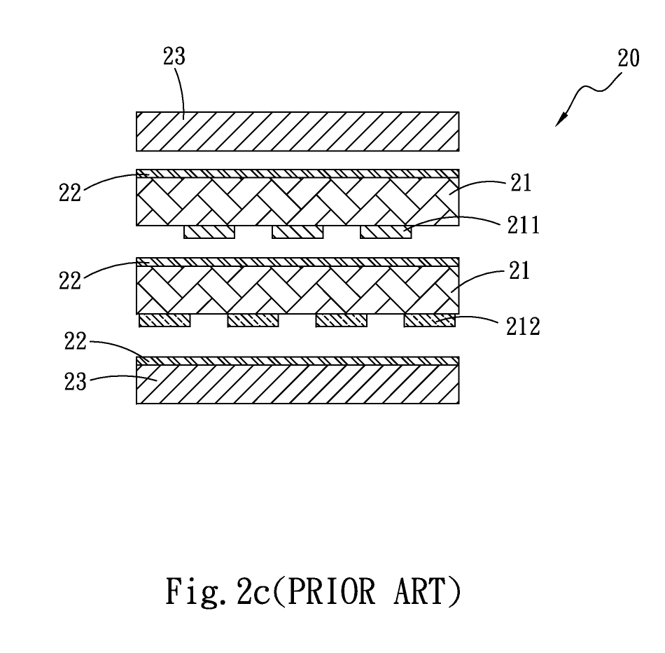

FIG. 2d is a plane view showing a further conventional touch pad;

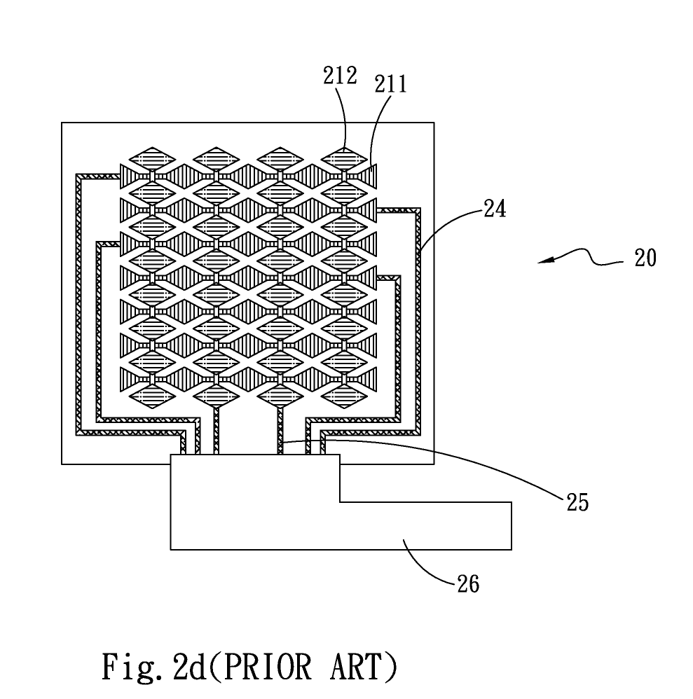

FIG. 3 is an exploded cross-sectional view showing a transparent touch pad of the present invention;

FIG. 4 is a plane view showing the transparent touch pad of the present invention; and

FIG. 5 is a flow chart showing the method for manufacturing the transparent touch pad of the present invention.

### DETAILED DESCRIPTION OF THE INVENTION

The above objectives and structural and functional features of the present invention will be described in more detail with reference to preferred embodiments thereof shown in the accompanying drawings

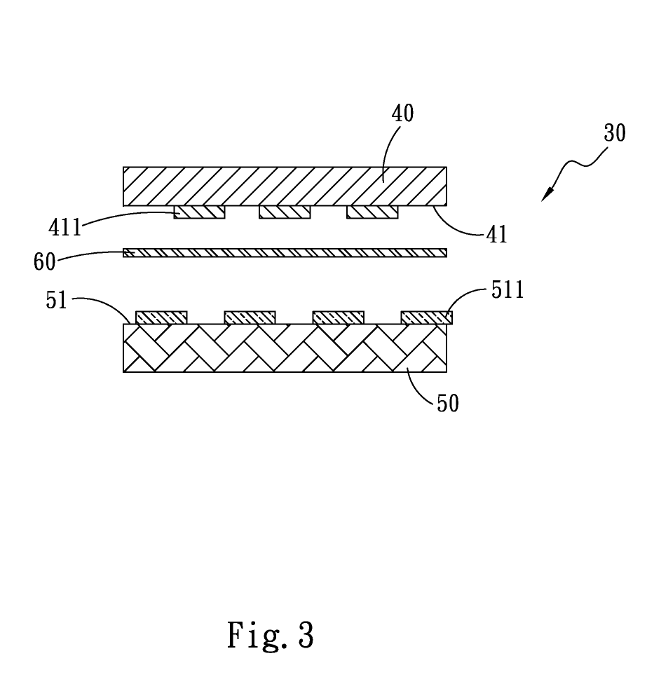

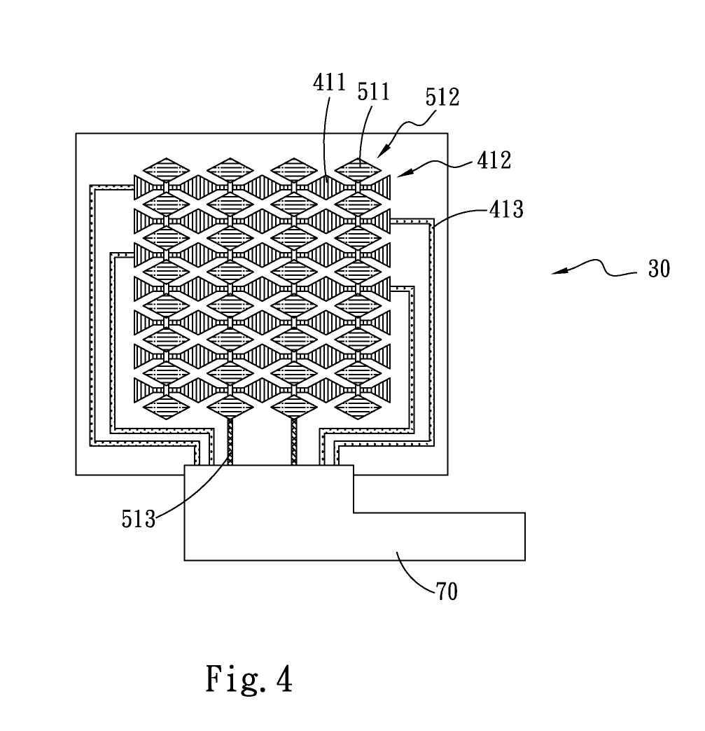

Please refer to FIGS. 3 and 4, which are schematic views showing a preferred embodiment of the present invention. The transparent touch pad 30 of the present invention includes a first transparent substrate 40, a second transparent substrate 50 and an adhesion layer 60. The first transparent substrate 40 is a glass substrate or a PMMA substrate. One side of the first transparent substrate 40 has a first surface 41 on which a plurality of first sensing conductors 411 is coated. The first sensing conductors 411 are electrically connected to each other along a first direction (a horizontal direction) to form a plurality of first conductor groups 412. At least one end of each first conductor group 412 is connected with a first conductive wire 413 which is a transparent conductive wire.

The second transparent substrate 50 is a PET substrate, and is disposed opposite to the first surface 41 of the first transparent substrate 40 and has a second surface 51 opposite to the first surface 41. The surface resistance of the first surface 41 is smaller than that of the second surface 51. The second surface 51 is provided with a plurality of second sensing conductors 511. The second sensing conductors 511 are electrically connected to each other along a second direction (a vertical direction) to form a plurality of second conductor groups 512. The second conductor groups 512 and the first conductor groups 412 are staggered and perpendicular to each other. At least one end of each second conductor group 512 is connected to a second conductive wire 513 which is an opaque conductive wire.

The adhesion layer 60 is made by transparent insulation glue and provided between the first transparent substrate 40 and the second transparent substrate 50. The two sides of the adhesion layer 60 are adhered to the first surface 41 and the second surface 51 respectively. The first sensing conductors 411 and the second sensing conductors 511 are adhered to each other with the adhesion layer 60 being disposed there between. By this arrangement, the first transparent substrate 40 is adhered to the second transparent substrate 50. The first conductive wire 413 and the second conductive wire 513 are separated by the adhesion layer 60 and electrically connected to a flat cable 70. The flat cable 70 is further connected to a controller (not shown).

In the present embodiment, the first conductor groups 412 formed by the first sensing conductors 411 which are electrically connected to each other on the first surface 41 of the first transparent substrate 40 are X-axis conductors. One end of the first conductor group 412 is connected with the first conductive wire 413. The first transparent substrate 40 made by glass or PMMA is subjected to a low-resistance treatment, so that the first conductive wire 413 can be used as conductors without using silver glue or other low-resistance conductors. In this way, one-dimension arrangement of sensing conductors is achieved. Since only one dimension arrangement of sensing conductors is made on the glass, the degree of precision is lower. Thus, only an etching process having a low cost is utilized to manufacture the transparent touch pad of the present invention. As a result, a lithographic process is not required.

The second conductor groups 512 formed by the second sensing conductors 511 which are electrically connected to each other on the second surface 51 of the second transparent substrate 50 are Y-axis conductors. One end of the second conductor group 512 is connected with the second conductive wire 513. In this way, a transparent touch pad 30 having two-dimensional arrangement of sensing conductors is formed. The first conductive wire 413 is a transparent conductive wire, and the second conductive wire 513 is an opaque conductive wire. Since the flat cable 70 is disposed near the second conductive wire 513, the length of the second conductive wire 513 can be reduced. Since the first conductive wires 413 are transparent conductive wires, the electrical connection area from the first conductive wires 413 to the flat cable 70 will not affect the area of visible region of the transparent touch pad. Thus, the area of visible region of the transparent touch pad 30 is increased. Further, since the second transparent substrate 50 is usually made by a PET substrate that is easy to process, an etching process can be directly used to manufacture the transparent touch pad of the present invention with a desired degree of precision. Therefore, a high cost caused by a conventional lithographic process for manufacturing two-dimensional arrangement of sensing conductors on the glass can be avoided. In this way, the transparent touch pad of the present invention can be made with a simple structure and a reduced production cost.

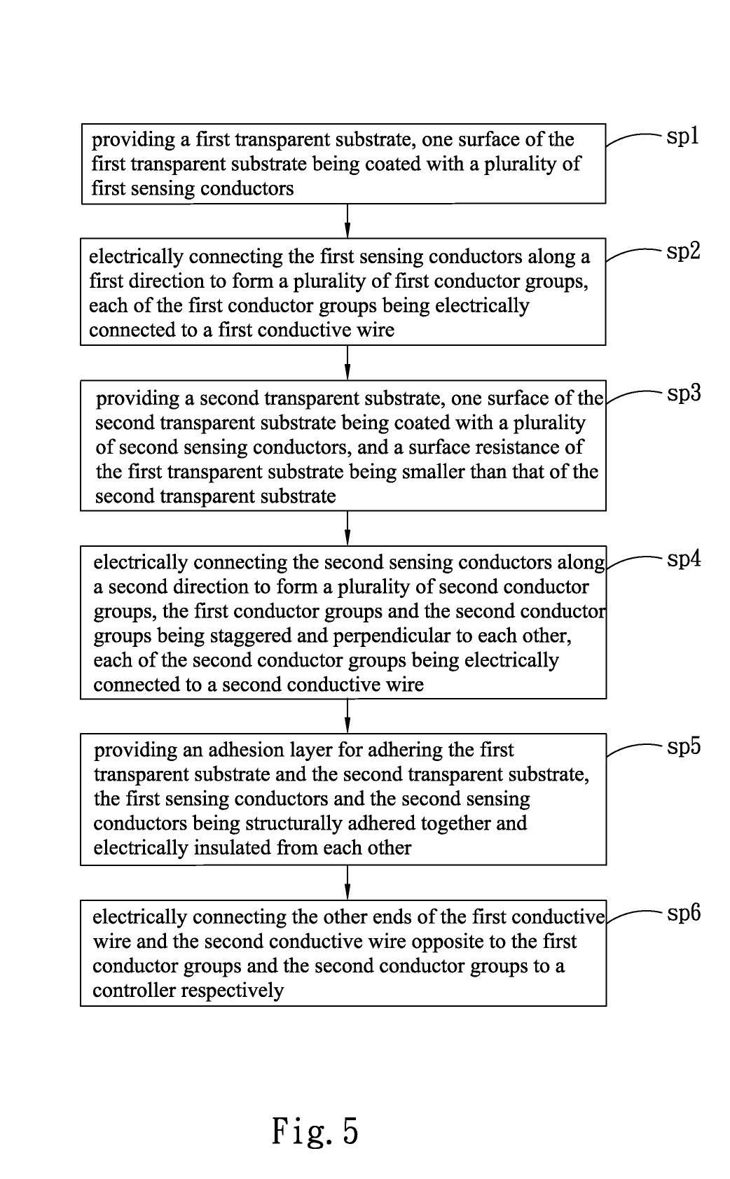

Please refer to FIGS. 3 to 5. FIG. 5 is a flow chart showing the method for manufacturing the transparent touch pad 30 of the present invention. The method of the present invention includes the following steps:

In a step 1 (sp1), a first transparent substrate is provided. One surface of the first transparent substrate is coated with a plurality of first sensing conductors.

In a step 2 (sp2), a plurality of first sensing conductors is electrically connected to each other along a first direction to form a plurality of first conductor groups. Each of the first conductor groups is electrically connected to a first conductive wire.

In a step 3 (sp3), a second transparent substrate is provided. One surface of the second transparent substrate is coated with a plurality of second sensing conductors. The surface resistance of the first transparent substrate is smaller than that of the second transparent substrate.

In a step 4 (sp4), a plurality of second sensing conductors is electrically connected to each other along a second direction to form a plurality of second conductor groups. The second conductor groups and the first conductor groups are staggered and perpendicular to each other. Each of the second conductor groups is electrically connected to a second conductive wire.

In a step 5 (sp5), an adhesion layer is provided to adhere the first transparent substrate and the second transparent substrate. The first sensing conductors and the second sensing conductors are structurally adhered together and electrically insulated from each other.

In a step 6 (sp6), the other ends of the first conductive wire and the second conductive wire opposite to the first conductor groups and the second conductive groups are electrically connected to a controller.

First, the first transparent substrate 40 is provided. One surface of the first transparent substrate 40 is coated with the plurality of first sensing conductors 411. The first sensing conductors 411 are electrically connected to each other along a first direction (a horizontal direction) to form the first conductor groups 412. Each of the first conductor groups 412 is electrically connected to the first conductive wire 413. Further, the second transparent substrate 50 is provided. The surface resistance of the first transparent substrate 40 is smaller than that of the second transparent substrate 50. One surface of the second transparent substrate 50 is coated with the plurality of second sensing conductors 511. The second sensing conductors 511 are electrically connected to each other along a second direction (a vertical direction) to form the second conductor groups 512. The second conductor groups 512 and the first conductor groups 412 are staggered and perpendicular to each other. Each of the second conductor groups 512 is electrically connected to the second conductive wire 513. An adhesion layer 60 is provided to adhere the first transparent substrate 40 to the second transparent substrate 50, so that the first sensing conductors 411 and the second sensing conductors 511 are structurally adhered together and electrically insulated from each other. The other ends of the first conductive wire 413 and the second conductive wire 513 opposite to the first conductor groups 412 and the second conductive groups 512 are electrically connected to a flat cable 70 respectively. Then, the flat cable 70 is electrically connected to a controller (not shown). In this way, the transparent touch pad 30 having two-dimensional arrangement of sensing conductors can be obtained. Since the first conductive wire 413 is transparent, the area of a visible region of the transparent touch pad 30 is increased. Thus, an etching process is directly used to manufacture the transparent touch pad of the present invention with a desired degree of precision. Therefore, a high cost caused by a conventional lithographic process for manufacturing two-dimensional arrangement of sensing conductors on the glass can be avoided. In this way, the transparent touch pad of the present invention can be made with a simple structure and a reduced production cost.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A transparent touch pad, including:
a first transparent substrate having a first surface, the first surface being provided with a plurality of first sensing conductors;
a second transparent substrate provided on one side of the first transparent substrate, the second transparent substrate having a second surface corresponding to the first surface, the second surface being provided with a plurality of second sensing conductors, a surface resistance of the first transparent substrate being smaller than that of the second transparent substrate; and
an adhesion layer provided between the first transparent substrate and the second transparent substrate, the adhesion layer being adhered to the first surface and the second surface in such a manner that the first sensing conductors and the second sensing conductors are electrically insulated from each other.

2. The transparent touch pad according to claim 1, wherein the first transparent substrate includes any one of a glass substrate and a PMMA substrate.

3. The transparent touch pad according to claim 1, wherein the second transparent substrate includes a PET substrate.

4. The transparent touch pad according to claim 1, wherein the first sensing conductors are electrically connected with each other along a first direction to form a plurality of first conductor groups, the second sensing conductors are electrically connected to each other along a second direction to form a plurality of second conductor groups.

5. The transparent touch pad according to claim 4, wherein at least one end of each first conductor group is connected with a first conductive wire, and wherein at least one end of each second conductive group is connected with a second conductive wire.

6. The transparent touch pad according to claim 5, wherein the first conductive wire is a transparent conductive wire.

7. The transparent touch pad according to claim 5, wherein the second conductive wire is an opaque conductive wire.

8. The transparent touch pad according to claim 5, wherein the other ends of the first conductive wire and the second conductive wire opposite to the first conductor groups and the second conductor groups are electrically connected to a controller respectively.

9. The transparent touch pad according to claim 1, wherein the adhesion layer is transparent insulation glue.

10. The transparent touch pad according to claim 4, wherein the first conductor groups and the second conductor groups are staggered and perpendicular to each other.

11. A method for manufacturing a transparent touch pad, including steps of:
providing a first transparent substrate, one surface of the first transparent substrate being coated with a plurality of first sensing conductors;
providing a second transparent substrate, a surface resistance of the first transparent substrate being smaller than that of the second transparent substrate, one surface of the second transparent substrate being coated with a plurality of second sensing conductors; and
providing an adhesion layer for adhering the first transparent substrate and the second transparent substrate, the first sensing conductors and the second sensing conductors being structurally adhered together and electrically insulated from each other.

12. The method according to claim 11, wherein the first sensing conductors are electrically connected to each other along a first direction to form a plurality of first conductor groups, each of the first conductor groups is electrically connected to a first conductive wire.

13. The method according to claim 12, wherein the second sensing groups are electrically connected to each other along a second direction to form a plurality of second conductor groups, the second conductor groups and the first conductor groups are staggered and perpendicular to each other, each of the second conductor groups is electrically connected to a second conductive wire.

14. The method according to claim 13, further including a step of electrically connecting the other ends of the first conductive wire and the second conductive wire opposite to the first conductor groups and the second conductor groups to a controller respectively.
